(19) United States
(12) Patent Application Publication
(10) Pub. No.: US 2005/0210015 A1
(43) Pub. Date: Sep. 22, 2005

(54) System and method for patient identification for clinical trials using content-based retrieval and learning

(76) Inventors: Xiang Sean Zhou, Plainsboro, NJ (US); Dorin Comaniciu, Princeton Jct., NJ (US); Gudrun Zahlmann, Neumarkt (DE)

Correspondence Address: Siemens Corporation;Intellectual Property Department, 170 Wood Avenue South, Iselin, NJ, 08830, US

(21) Appl. No.: 11/082,570

(22) Filed: Mar. 17, 2005

Related U.S. Application Data
(60) Provisional application No. 60/554,462, filed on Mar. 19, 2004.

(51) Int. Cl. G06F 7/00

(52) U.S. Cl. 707/3

(57) ABSTRACT

A method for selecting a subject for a clinical study includes providing a criteria for selecting one or more subjects from a database, performing a content based similarity search of the database to retrieve subjects who meet the selection criteria, presenting the selected subjects to a user, and receiving user feedback regarding the selected subjects. The feedback can concern whether each of the selected subjects presented to the user is suitable for the clinical study. The method also includes learning from the feedback to improve the content based similarity search, performing an improved content based similarity search of the database to retrieve additional subjects who meet the selection criteria, and presenting the additional subjects to the user.

### CROSS REFERENCE TO RELATED UNITED STATES APPLICATIONS

This application claims priority from “Patient Identification for Clinical Trials using Content-Based Retrieval and Learning”, U.S. Provisional Application No. 60/554,462 of Zhou, et al., filed Mar. 19, 2004, the contents of which are incorporated herein by reference.

### TECHNICAL FIELD

This invention is directed to identifying patients for clinical trials.

### DISCUSSION OF THE RELATED ART

The large, heterogeneous, and ever-increasing volume of patient databases, the difficulties of manually indexing these collections, and the inadequacy of human language alone to describe their rich contents, such as image information that is visually recognizable and medically significant, all provide impetus for research and development toward practical content-based image and information retrieval (CBIR) systems that could become a standard offering of the medical library of the future. Although CBIR has been used for diagnosis support during or after clinical trials, there is no prior work focusing on the application of content-based retrieval and learning for the purpose of patient identification for recruitment prior to clinical trials.

### SUMMARY OF THE INVENTION

Exemplary embodiments of the invention as described herein generally include methods and systems for the use of CBIR techniques for patient identification for clinical trials. According to an embodiment of the invention, a patient identification process for clinical trials can be modeled as a cross-modality content-based retrieval process, with integration of multiple modalities, including image, genomic, clinical, and financial information, in an automatic and semi-automatic content-based retrieval system with experts in the loop. According to an embodiment of the invention, textual information can be combined with categorical, numerical, and visual data representing clinical, genomic, financial, and imaging information. Computer vision and machine learning tools can extract descriptors or features to represent the visual and genomic data. A system according to an embodiment of the invention can retrieve qualified patients from a large, heterogeneous database based on learning from examples selected by and on-line feedbacks from the experts. On-line learning from user feedback can provide flexibility for the user to easily select patients based on different criteria, without tedious and difficult parameter tuning for the distance measures by the user. The patient identification process is supported by query by example, query by profile/template/sketch, and learning from user feedback. According to an embodiment of the invention, long-term feedback and learning from multiple experts is supported, which can be performed in the background throughout the usage of the retrieval system. Long-term learning can provide automatic and semiautomatic knowledge representation and discovery. With sufficient statistics, hidden correlations or dependencies across modalities can be discovered and represented in quantifiable forms. With an expert user in the process, a CBIR system according to an embodiment of the invention can support not only basic similarity searching, but also on-line, adaptive distance metric tuning of the search and retrieval algorithms according to the specific need of the current user and the current task.

According to an aspect of the invention, there is provided a method for identifying a patient for a clinical study including the steps of creating a database of patients and patient information, providing a criteria for selecting one or more patients from the database, performing a content based similarity search of the database to retrieve the one or more patients who meet the selection criteria, and presenting said selected one or more patients to a user.

According to a further aspect of the invention, the criteria for selecting one or more patients comprises providing example patient suitable for said study to a search engine, and wherein said criteria is determined from characteristic feature values of said example patient.

According to a further aspect of the invention, the criteria for selecting one or more patients comprises providing a plurality of example patients suitable for said study to a search engine, and wherein said criteria is determined from characteristic feature values of said plurality of example patients.

According to a further aspect of the invention, the database is created by extracting features that support distance based comparisons from at least one of financial, demographic, image, clinical, and genomic data.

According to a further aspect of the invention, these features include numerical data and discrete information represented by words.

According to a further aspect of the invention, the similarity search comprises a distance measure performed on said selection criteria.

According to a further aspect of the invention, the method includes receiving user feedback regarding the one or more selected patients, wherein the feedback concerns whether each of the one or more selected patients presented to the user is suitable for the clinical study, improving said content based similarity search based on said user feedback, performing the improved content based similarity search of the database to retrieve one or more additional patients who meet the selection criteria, and presenting said selected additional patients to the user.

According to a further aspect of the invention, improving said content based similarity search comprises selecting and re-weighting distance measures of said features stored in said database.

According to a further aspect of the invention, improving said content based similarity search comprises utilizing discriminative density estimators and kernel machine techniques.

According to a further aspect of the invention, improving said content based similarity search comprises a biased discriminant analysis.

According to a further aspect of the invention, the method includes selecting one or more additional patients wherein said content based similarity search is uncertain whether said additional patients meet the selection criteria.

According to a further aspect of the invention, the method includes using statistical analysis to determine consistent hidden information and dependencies among keywords and key-features within said database.

According to a further aspect of the invention, the steps of receiving user feedback, learning from said feedback, performing an improved content based similarity search, and presenting said selected additional subjects are repeated until a sufficient sample of subjects for said clinical study has been selected.

According to another aspect of the invention, there is provided a program storage device readable by a computer, tangibly embodying a program of instructions executable by the computer to perform the method steps for identifying a patient for a clinical study.

### BRIEF DESCRIPTION OF THE DRAWINGS

FIG. 1 presents a system diagram illustrating a content-based retrieval for patient identification for clinical trials, according to an embodiment of the invention.

FIG. 2 illustrates decision surfaces calculated using three different kernel machines, according to an embodiment of the invention.

FIG. 3 displays the results of a simulated experiment on long-term learning from multiple sessions of user feedbacks, according to an embodiment of the invention.

FIG. 4 presents a flowchart of a relevance feedback method according to an embodiment of the invention.

FIG. 5 is a block diagram of an exemplary computer system for implementing a CBIR system, according to an embodiment of the invention.

### DETAILED DESCRIPTION OF THE PREFERRED EMBODIMENTS

Exemplary embodiments of the invention as described herein generally include systems and methods for patient identification for clinical trials using content-based retrieval and learning. In the interest of clarity, not all features of an actual implementation which are well known to those of skill in the art are described in detail herein.

A content-based retrieval and learning system according to an embodiment of the invention can provide an automatic patient identification that incorporates knowledge and intelligence. By intelligence is meant the use of machine learning, image processing, and computer vision algorithms for feature extraction from genomic data, images, or image sequences, so that evaluations of non-numerical and non-categorical information sources can be analyzed by machines. By knowledge is meant the use of AI and machine learning tools for extracting quantitative dependencies among different data modalities and disease categories, either from the data or from relevance feedback learning processes. These dependencies can represent new knowledge, or known knowledge but in a more quantitative form.

A retrieval system for patient identification according to an embodiment of the invention can include modules for performing the following functions: (1) content extraction and representation; (2) patient selection through content-based similarity search; (3) user feedback and on-line learning; and (4) long-term learning from user inputs and feedbacks.

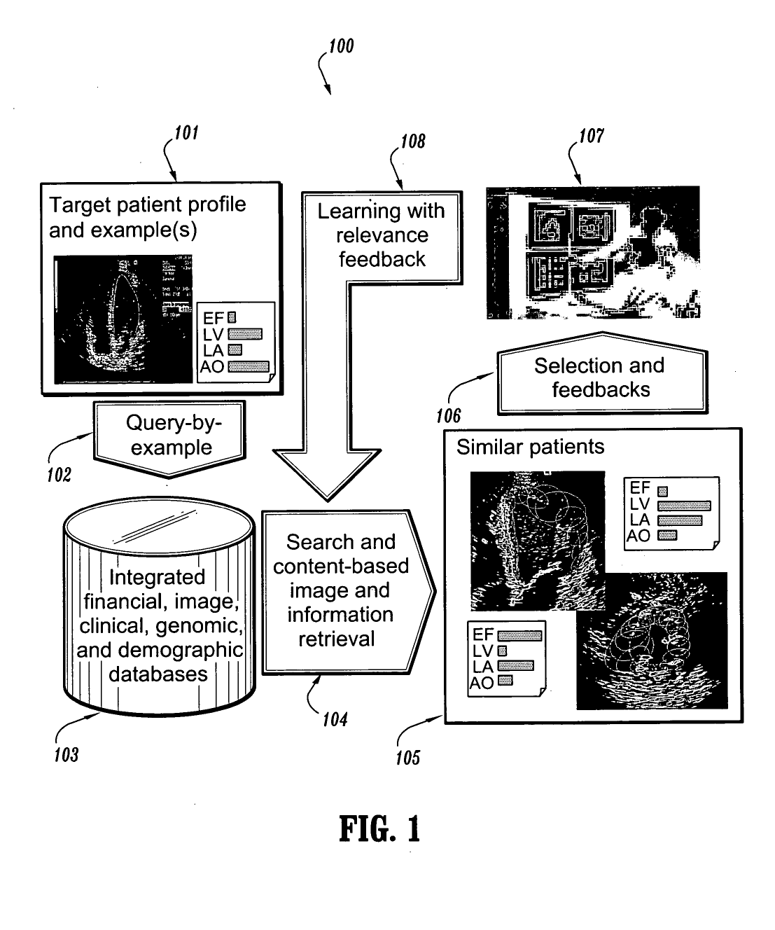

FIG. 1 presents a block diagram illustrating a content-based retrieval system 100 for patient identification for clinical trials that integrates information from multiple modalities with short-term and long-term learning from expert feedback, according to an embodiment of the invention. Referring now to the figure, a first step towards a unified search using heterogeneous information sources according to an embodiment of the invention is to extract features that support distance-based comparisons from all sources and put them in one metric space. This information is compiled in database 103, and includes financial, demographic, image, clinical, and genomic data. In the cases of images, such features can include color, texture, shape, geometry, or motion of anatomical structures and objects in medical images or sequences of images. One example imaging modality is echocardiography, an example of which is illustrated in FIG. 1, and where the potential visual feature extraction tasks include automatic border detection and motion tracking and classification. Clinical data such as age, sex, and patient history, can have an influence on the patient selection process. To incorporate numerical and discrete information represented by words, techniques such as information fusion, clustering and modeling in joint word and feature space, combining latent semantic contents of text documents together with visual statistics, associating words to images to build a semantic network of keywords to support retrieval in a joint space, and learning word associations from multi-user multi-session relevance feedbacks, can be incorporated into a CBIR system according to an embodiment of the invention.

Once a suitable database is in place, a physician planning a clinical trial would determine a target patient profile 101 suitable for the planned trial, along with one or more examples of patients fitting this profile. The search and content-based image and information retrieval algorithms according to an embodiment of the invention can include a query-by-example based search and retrieval, and a query-by-profile/template/sketch based search and retrieval. In a query-by-example scenario a user submits an example patient who fits the desired criteria to the search engine, while in a query-by-profile/template/sketch scenario, a user can submit a plurality of suitable patients to the search engine. A CBIR system according to an embodiment of the invention can infer appropriate selection criteria from the characteristic feature values of the example (or examples) provided. Alternatively, a user can provide a value or a range of values for one or more characteristics of one or more suitable patients, such as an average value and a standard deviation for a characteristic of a distribution of patients. An initial retrieval result for the patient selection is based on a direct similarity matching between the input, i.e. characteristics of the patients submitted as examples, and those patients in the database. The initial distance measure can be any suitable distance measure, such as a Euclidean distance, weighted Euclidean distance, Mahalanobis distance, or in the case of query-by-profile/template/sketch, where the descriptor can be a distribution, the initial distance measure can be a K-L divergence, a histogram intersection, or an Earth Movers Distance, etc. These distance measures are exemplary, and other distance measures as are known in the art are within the scope of the embodiment of the invention. The subjects returned to the user will be, in the case of query-by-example, those subjects who either exactly match the example or closely match the example by some closeness criteria provided by the user. In the case of query-by-profile/template/sketch, subjects within the ranges provided will be retuned to the user.

In FIG. 1, a query-by-example 102 to the database 103 performs search and content-based image and information retrieval 104 such as those described above to yield a pool of similar patients 105. This pool of patients can be further refined by expert feedback 106 to yield a selection of patients 107 for the clinical trial. The system can utilize learning with relevance feedback 108, described below, to improve and update the search and content-based image and information retrieval 104.

According to an embodiment of the invention, user interaction can improve the patient selection process to better match the intentions and needs of the doctors conducting the trial. This can be achieved by techniques referred to herein as relevance feedback. Relevance feedback can treat each task as being different, as even for the same trial a researcher may want to select patients using different criteria. Although current CBIR systems provide interfaces for a user to hand-tune weights on different features to support such requests, the similarity measure in the researcher's mind is often not easily expressed in terms of exact weights of system parameters. In addition, the researcher's perceived similarity may not be expressible by a linear weighting scheme, which assumes feature independence that may not be true in reality.

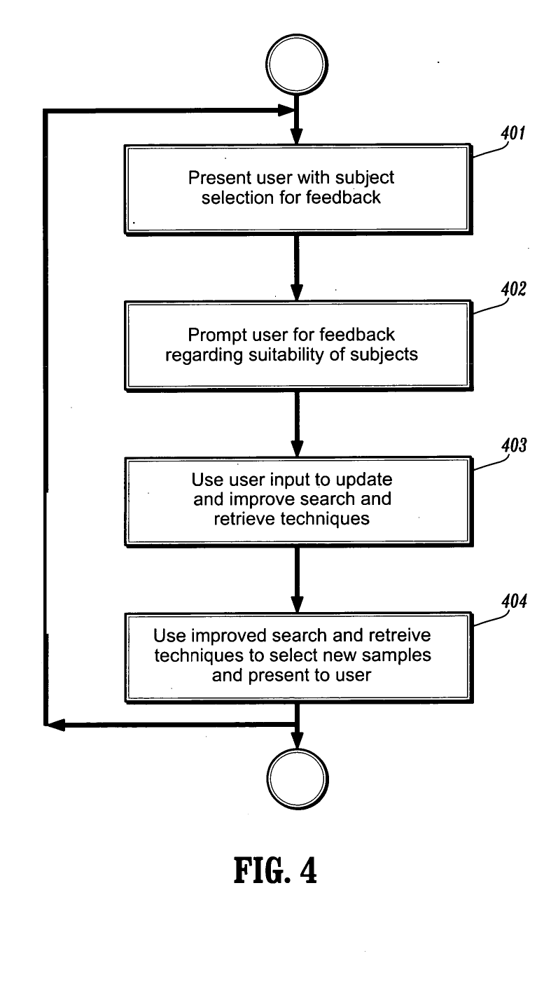

A flowchart of a relevance feedback method according to an embodiment of the invention is presented in FIG. 4. A user is presented at step 401 with a selection of one or more patients for a planned trial and is prompted for feedback regarding which patients are suitable and those who are not. These patients could be those selected according to the search and content-based image and information retrieval of step 104 of FIG. 1. Rather than prompting the user to fine-tune weights in the patent example or patient profile, a user can be prompted to point out, at step 402, from current recommended patients juts presented, who are suitable and who are not. The CBIR system can utilize the user input at step 403 to improve and update the search and content-based image and information retrieval techniques used for selecting potential patients from the database. Possible algorithms for improving the search and content-based image and information retrieval techniques include both simple techniques that select and re-weight axes of the feature space to maximize positive returns using the weighted Euclidean distance or other distance measures, or more advanced techniques that involve kernel machines and discriminative density estimators such as one-class support vector machine and biased discriminant analysis. These more advances techniques are useful in handling situations with small user samples, as described below.

At step 403, the system uses the improved search and content-based image and information retrieval to select a new sample of potential trial subjects. The system then returns to step 401 to present the new selection to the user. These new samples are representative of a system that can learn from user feedback and return more cases that are a good match according to the feedback. This feedback process can be repeated as many times as necessary until a sufficient patient sample has been selected for the trials.

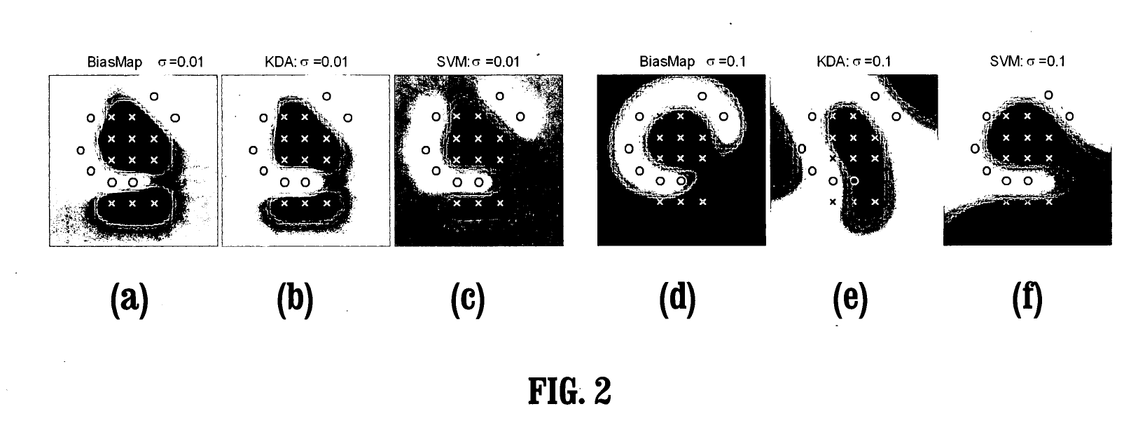

The relevance feedback techniques just presented involve the use of on-line user interactions. Such user interactions typically provide a relatively small number of training samples, usually in the dozens as compared to hundreds or thousands for off-line training. This small training sample can cause two difficulties in a statistical learning framework: the bias in the density estimates, and the asymmetry in representative power for different classes. Asymmetry in representative power means that a small number of examples cannot represent the positive and the negative classes well enough, and in most cases, one is much worse than the other. For example, five horses represents the “horse” class much better than five examples of non-horse animals represents the “non-horse” class. One technique for handling small samples is biased discriminant analysis (BDA), a kernel machine based discriminative density estimator. FIG. 2 illustrates a comparison among three kernel machines known in the art of statistical learning, using a simple, artificial example. The kernel machines tested are BDA, kernel discriminant analysis (KDA), and support vector machine (SVM), shown in, respectively, panels (a) and (d), (b) and (e), and (c) and (f). Referring to the figure, the decision surfaces of BDA, KDA, and SVM are shown. The open circles represent positive examples and the crosses negative examples. The grey level indicates the closeness to the positive centroid in the nonlinearly transformed space: the brighter, the closer. At an overfitting scale (σ=0.01), depicted in figures (a)-(c), the three kernel machines are similar. Overfitting means that the algorithm works well for all the data in the training set, but poorly for unseen testing data. However, at an improved scale (σ=0.1), depicted in figures (d)-(f), SVM and KDA separate the positive and negative but assign large unknown regions to the positive class, while BDA confines it around the positive points while still retaining discriminative power.

Another aspect of relevance feedback, according to an embodiment of the invention, are active learning techniques. Active learning refers to a strategy for the learner (i.e., the machine) to actively select samples to query a teacher (i.e., the user) for feedback to maximize information gain or minimize entropy/uncertainty in decision-making. Active learning can provide more efficient and more intelligent user interactions. Referring back to FIG. 4, one implementation of active learning in a relevance feedback technique according to an embodiment of the invention, is to present to the user at step 401 not only the most suitable patients but also patients the system is uncertain about, so that the system can maximally improve its selection criteria after receiving feedback from the user at step 402 on these uncertain cases. These patients could be those patients whose feature similarity distance measures are insufficiently close to be automatically included in an initial retrieval, but insufficiently far apart to be excluded with complete confidence. For example, these uncertain cases could be those whose feature similarity distances are just outside the range of a user supplied criteria or cutoff. In other cases, these uncertain cases could be patients for whom some feature values are within those feature values of the examples initially specified by the user, while other feature values are outside those of the user supplied examples.

During long-term usage of a retrieval system of an embodiment of the invention, each user input and feedback comprises valuable information. In accordance with an embodiment of the invention, long-term learning from multiple experts over time can be incorporated by using statistical analysis to identify consistent hidden information and dependencies among the keywords and the key-features within databases. Such long-term learning can, as a by-product, signal unusual or changing behavior/action on the part of a user. With expert guidance, long-term relevance feedback tools can facilitate advanced research activities toward the discovery of new disease patterns/trends and drug interactions or effects. In accordance with an embodiment of the invention, an implementation for long term learning includes one or more processes that can be invoked by the improvement and updating of the search and content-based image and information retrieval techniques of step 403 of FIG. 4. These processes can execute in the background without input from or awareness by the user.

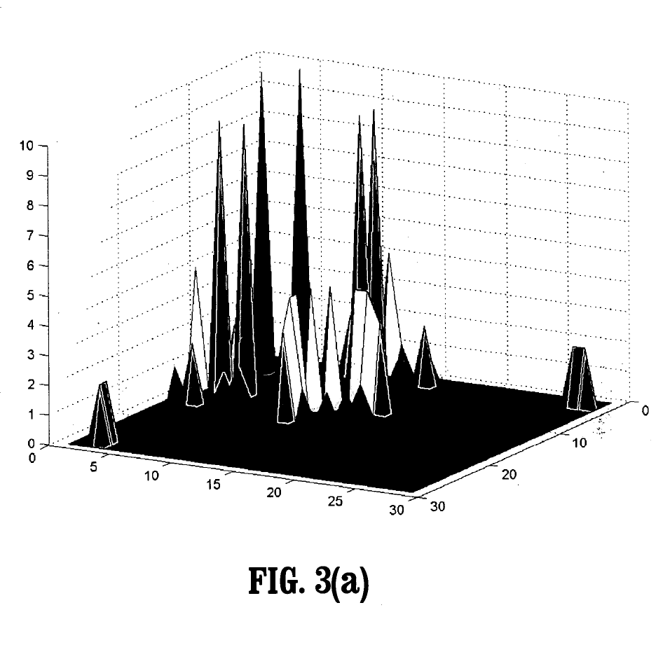

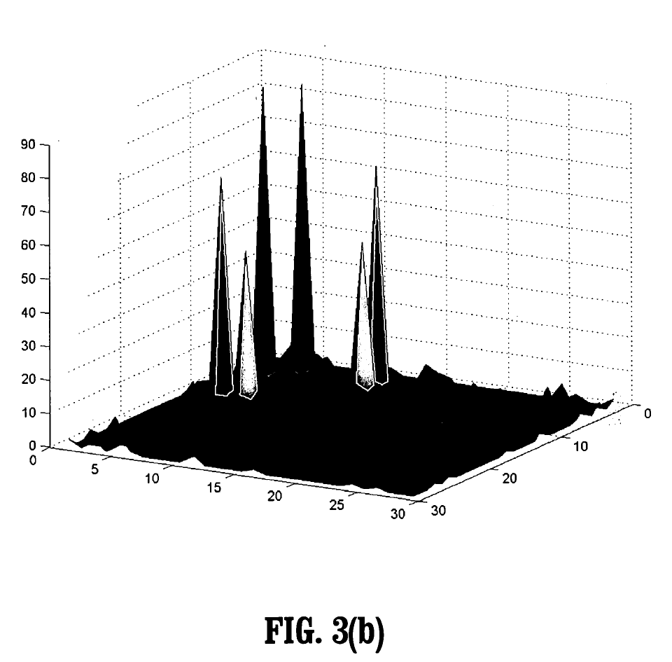

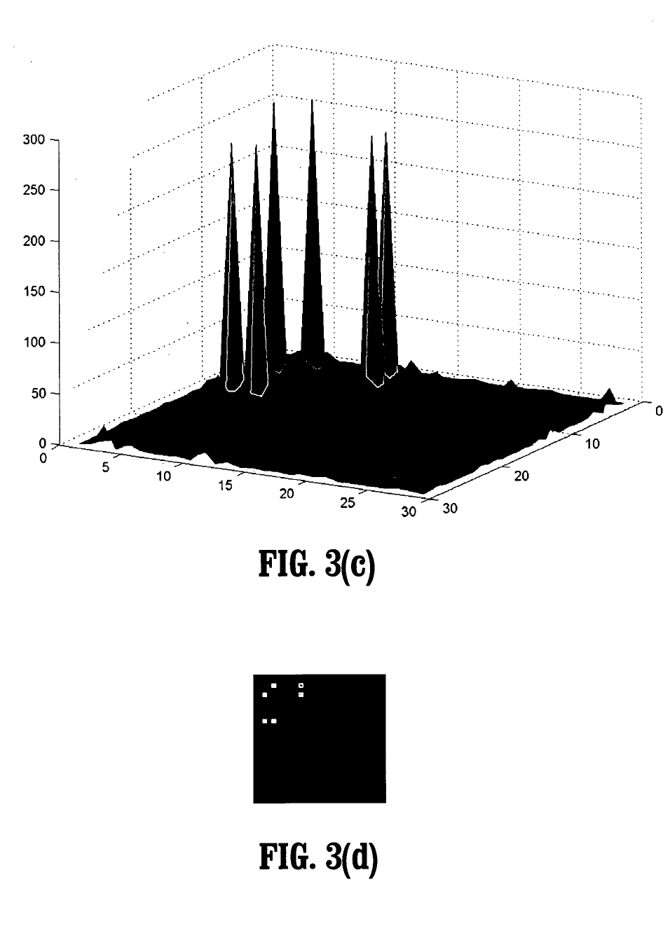

Simulations have shown the feasibility of such long-term learning. The results of a simulated experiment on long-term learning from multiple sessions of user feedbacks are displayed in FIG. 3. Referring to the figure, a concept similarity matrix for a 30 word vocabulary and a 5000 image database with up to 3 keywords per image is shown. FIG. 3(a) shows the concept similarity matrix after 5 rounds of training; FIG. 3(b) after 20 rounds of training; FIG. 3(c) after 80 rounds of training; and FIG. 3(d) shows the corresponding flat view of the ground truth. These results show that after only 20 rounds of learning, the concept dependency matrix (FIG. 3b) already closely resembles the simulated ground truth (FIG. 3d). Similar results were obtained for a vocabulary of 1000 words.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

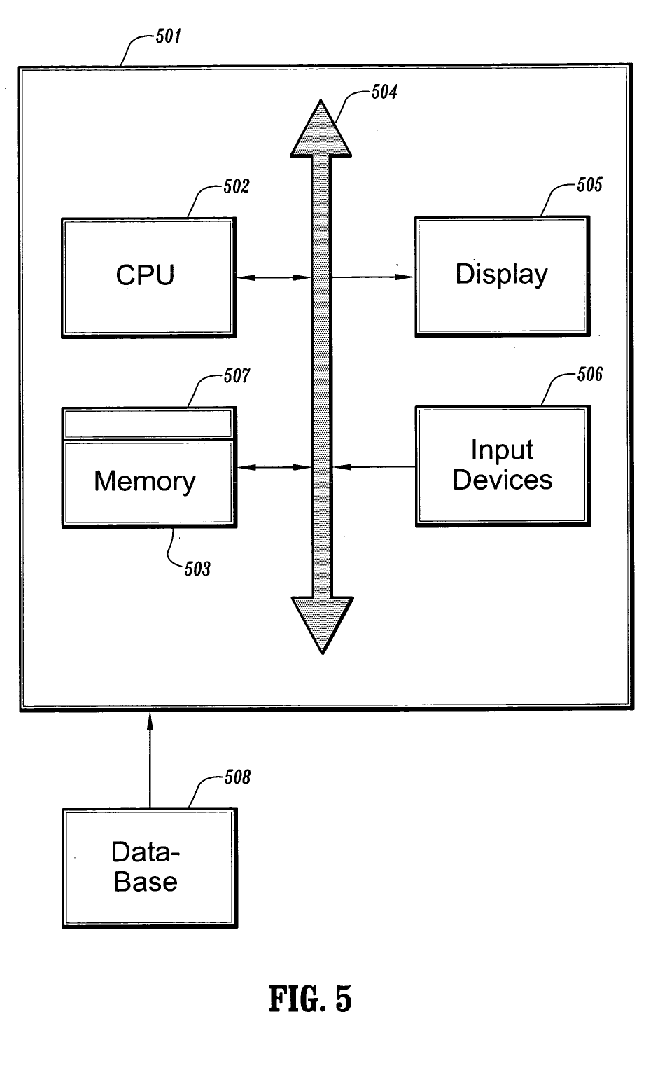

Referring now to FIG. 5, according to an embodiment of the present invention, a computer system 501 for implementing the present invention can comprise, inter alia, a central processing unit (CPU) 502, a memory 503 and an input/output (I/O) interface 504. The computer system 501 is generally coupled through the I/O interface 504 to a display 505 and various input devices 506 such as a mouse and a keyboard. The computer system 501 is also connected to a database 508. The database connection can be over a computer network, such as a local area network, including a wireless network, or over a global network, such as the Internet or a dial-up network. The support circuits can include circuits such as cache, power supplies, clock circuits, and a communication bus. The memory 503 can include random access memory (RAM), read only memory (ROM), disk drive, tape drive, etc., or a combinations thereof. The present invention can be implemented as a routine 507 that is stored in memory 503 and executed by the CPU 502 to process the information from the database 508. As such, the computer system 501 is a general purpose computer system that becomes a specific purpose computer system when executing the routine 507 of the present invention.

The computer system 501 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for identifying a patient for a clinical study, said method comprising the steps of:
creating a database of patients and patient information;
providing a criteria for selecting one or more patients from the database;
performing a content based similarity search of the database to retrieve the one or more patients who meet the selection criteria; and
presenting said selected one or more patients to a user.

2. The method of claim 1, wherein said criteria for selecting one or more patients comprises providing an example patient suitable for said study to a search engine, and wherein said criteria is determined from characteristic feature values of said example patient.

3. The method of claim 1, wherein said criteria for selecting one or more patients comprises providing a plurality of example patients suitable for said study to a search engine, and wherein said criteria is determined from characteristic feature values of said plurality of example patients.

4. The method of claim 1, wherein said database is created by extracting features that support distance based comparisons from at least one of financial, demographic, image, clinical, and genomic data.

5. The method of claim 4, wherein said features include numerical data and discrete information represented by words.

6. The method of claim 4, wherein the similarity search comprises a distance measure performed on said selection criteria.

7. The method of claim 6, further comprising the steps of:
receiving user feedback regarding the one or more selected patients, wherein the feedback concerns whether each of the one or more selected patients presented to the user is suitable for the clinical study;
improving said content based similarity search based on said user feedback;
performing the improved content based similarity search of the database to retrieve one or more additional patients who meet the selection criteria; and
presenting said selected additional patients to the user.

8. The method of claim 7, wherein improving said content based similarity search comprises selecting and re-weighting distance measures of said features stored in said database.

9. The method of claim 7, wherein improving said content based similarity search comprises utilizing discriminative density estimators and kernel machine techniques.

10. The method of claim 9, wherein improving said content based similarity search comprises biased discriminant analysis.

11. The method of claim 1, further comprising the steps of selecting one or more additional patients wherein said content based similarity search is uncertain whether said additional patients meet the selection criteria.

12. The method of claim 1, further comprising using statistical analysis to determine consistent hidden information and dependencies among keywords and key-features within said database.

13. A method for selecting a subject for a clinical study, said method comprising the steps of:
providing a criteria for selecting one or more subjects for said clinical study;
performing a content based similarity search of a database to retrieve the one or more subjects who meet the selection criteria;
receiving user feedback regarding the one or more selected subjects, wherein the feedback concerns whether each of the one or more selected subjects presented to the user is suitable for the clinical study;
learning from said feedback to improve the content based similarity search;
performing an improved content based similarity search of the database to retrieve one or more additional subjects who meet the selection criteria; and
presenting said selected additional subjects to the user.

14. The method of claim 13, wherein the steps of receiving user feedback, learning from said feedback, performing an improved content based similarity search, and presenting said selected additional subjects are repeated until a sufficient sample of subjects for said clinical study has been selected.

15. A program storage device readable by a computer, tangibly embodying a program of instructions executable by the computer to perform the method steps for identifying a patient for a clinical study, said method comprising the steps of:
creating a database of patients and patient information;
providing a criteria for selecting one or more patients from the database;
performing a content based similarity search of the database to retrieve the one or more patients who meet the selection criteria; and
presenting said selected one or more patients to a user.

16. The computer readable program storage device of claim 15, wherein said criteria for selecting one or more patients comprises providing an example patient suitable for said study to a search engine, and wherein said criteria is determined from characteristic feature values of said example patient.

17. The computer readable program storage device of claim 15, wherein said criteria for selecting one or more patients comprises providing a plurality of example patients suitable for said study to a search engine, and wherein said criteria is determined from characteristic feature values of said plurality of example patients.

18. The computer readable program storage device of claim 1, wherein said database is created by extracting features that support distance based comparisons from at least one of financial, demographic, image, clinical, and genomic data.

19. The computer readable program storage device of claim 18, wherein said features include numerical data and discrete information represented by words.

20. The computer readable program storage device of claim 18, wherein the similarity search comprises a distance measure performed on said selection criteria.

21. The computer readable program storage device of claim 20, wherein the method further comprises the steps of:
receiving user feedback regarding the one or more selected patients, wherein the feedback concerns whether each of the one or more selected patients presented to the user is suitable for the clinical study;
improving said content based similarity search based on said user feedback;
performing the improved content based similarity search of the database to retrieve one or more additional patients who meet the selection criteria; and
presenting said selected additional patients to the user.

22. The computer readable program storage device of claim 21, wherein improving said content based similarity search comprises selecting and re-weighting distance measures of said features stored in said database.

23. The computer readable program storage device of claim 21, wherein improving said content based similarity search comprises utilizing discriminative density estimators and kernel machine techniques.

24. The computer readable program storage device of claim 23, wherein improving said content based similarity search comprises biased discriminant analysis.

25. The computer readable program storage device of claim 15, wherein the method further comprises the steps of selecting one or more additional patients wherein said content based similarity search is uncertain whether said additional patients meet the selection criteria.

26. The computer readable program storage device of claim 15, wherein the method further comprises using statistical analysis to determine consistent hidden information and dependencies among keywords and key-features within said database.
